(19) United States
(12) Patent Application Publication
(10) Pub. No.: US 2020/0316850 A1
(43) Pub. Date: Oct. 8, 2020

(54) ANATOMICAL SILICON MODELS AND ADDITIVE MANUFACTURING THEREOF

(71) Applicant: WACKER CHEMIE AG, Munich (DE)

(72) Inventors: Vera SEITZ, Muehldorf (DE); Hannah RIEDLE, Munich (DE)

(73) Assignee: WACKER CHEMIE AG, Munich (DE)

(21) Appl. No.: 16/652,370

(22) PCT Filed: Sep. 29, 2017
(86) PCT No.: PCT/EP2017/074911

§ 371 Date: Mar. 30, 2020

(51) Int. Cl. B29C 64/112; B29C 64/386; G09B 23/30

(52) U.S. Cl. CPC B29C 64/112; B33Y 80/00; G09B 23/30; B29C 64/386

(57) ABSTRACT

Anatomical models are produced by the drop on demand method using at least two structure forming materials which are different from each other, and as a result can accurately mimic either generic or patient specific structures, including, when desired, various colors and hardnesses representing different types of tissue.

### CROSS REFERENCE TO RELATED APPLICATIONS

This application is the U.S. National Phase of PCT Appln. No. PCT/EP2017/074911, filed Sep. 29, 2017, the disclosure of which is incorporated in its entirety by reference herein.

### BACKGROUND OF THE INVENTION

### 1. Field of the Invention

The invention relates to a method for the additive production of an anatomical model using a 3D printing device. The method is characterized in that at least one silicone rubber composition crosslinkable by electromagnetic radiation is used as a printing compound. As a result of layer-by-layer application of the printing compounds, the manufacturing of complex anatomies is moreover made possible.

The anatomical models thus generated are particularly realistic and can be of use to skilled medical personnel, for example for training, practicing surgical techniques, illustrating complex clinical pictures or patient-personalized, and preoperative surgical planning. The invention also relates to anatomical models produced by the aforementioned method.

### 2. Description of the Related Art

Anatomical models, also called biomodels, are of use in medicine for illustrating anatomical, healthy or pathological structures in the body. For example, they are used in the training of skilled medical personnel for depicting anatomy vividly on a haptic, three-dimensional model. Furthermore, medical procedures or surgical techniques can be demonstrated and practiced on such models. In this case, it is also possible to use specific instruments or to evaluate them for their later use. The models are also particularly suitable for testing novel medical products or surgical techniques.

To be able to carry this out under conditions that are as real as possible, the properties of the model must copy the particular tissue or body part as accurately as possible. In this case, important properties can be mechanical properties (such as, for example, hardness, elasticity, tear resistance, elongation at break, etc.), surface properties, optical properties, or behavior during use, such as, for example, cutting behavior or the possibility to place sutures on such a model.

In addition to generic anatomical models which depict an exemplary anatomical structure, there are patient-specific models which reproduce the anatomy of a particular patient. For example, these can be used by the treating physician for preoperative surgical planning or for educating the patient. On these models too, it is possible to practice different surgical strategies in advance or, for example, to determine appropriate instrument and implant sizes.

Because of the complexity and variability of the components in the area of anatomical models, additive manufacturing methods are particularly suitable for realizing haptic biomodels. Rigid anatomical models, such as, for example, bone, can be realized in various additive methods and different materials, predominantly thermoplastic materials.

However, what is disadvantageous is that these methods and printing materials are only suitable to a limited extent or are not suitable at all for the production of models for many anatomical structures. Especially for soft, elastic elements which deform easily under a load, these models do not provide a possibility of reconstructing treatment situations or surgical situations in a realistic manner. This concerns especially anatomical structures such as muscles, tendons, ligaments, blood vessels, cartilage, skin, mucosa and soft bone segments. Currently, such soft models are manufactured indirectly as coating or casting models of 3D-printed rigid negatives.

One disadvantage of indirect methods is that the manufacturing of complex anatomical models is not possible or is only possible with very great effort. Complex anatomical models usually contain one or more special geometrical features which prevent a conventional manufacture by means of casting methods. These can be undercuts, branches, inner cavities, channels, uneven surfaces, inner lattices/beam structures, bionic structures, branched networks on anatomical elements or similarly complicated structures.

Furthermore, all indirect methods have the disadvantage that many individual manufacturing steps are necessary in order to manufacture an anatomical silicone model and that a time-consuming, cost-intensive process with, in some cases, a high proportion of manual work steps is thus concerned.

The production of anatomical models by direct 3D printing methods is hardly known in the prior art.

WO 2015/107333 A1 describes a 3D printing method for producing anatomical prostheses composed of silicone elastomers by (continuous) extrusion of the crosslinkable silicone rubber composition from a mixer nozzle by means of syringe pumps. The curable silicone compositions described here are thus specially adapted for the continuous dispensing of thin strands and limited to two-component silicone compounds curable at room temperature (RTV). Moreover, only hardnesses between 10 and 26 Shore A and tensile strengths of 1.1 to 3.3 kN/m can be achieved. One disadvantage of this method is the precise placement of tiniest quantities of the silicone printing compound, placement which is not achievable for the printing of fine details. Furthermore, the time of crosslinking can no longer be influenced after the mixing of the two rubber components, and this has, inter alia, the disadvantage that regions of the silicone rubber composition that vary greatly in degree of crosslinking are contacted in the course of the printing operation (when the processing time of the printing compound is shorter than the printing time) or that the printed structure has no loadability (when the processing time of the printing compound is longer than the printing time).

WO 2013/072874 A1 describes a method for creating anatomical models from medical image data, which method is based on multijet printing of acrylate-based printing inks. Furthermore, the use of rubbery materials which, however, differ distinctly in their properties from the silicones used in this invention is described.

It is an object of the present invention to provide a method which allows the simple and cost-effective production of complex anatomical models. With regard to the mechanical and optical properties, the anatomical models are to copy the real tissues or body parts in question as accurately as possible.

### SUMMARY OF THE INVENTION

The invention thus relates to a method for the additive production of an anatomical model using a 3D printing device, the method comprising the following steps:

1) layer-by-layer application of one or more printing compounds to a support plate, to a foreign component positioned thereon or previously applied printing-compound layer, the printing compounds comprising at least one structure-forming printing material consisting of a silicone rubber composition crosslinkable by electromagnetic radiation;

2) crosslinking or incipient crosslinking of the applied printing compound by electromagnetic radiation;

3) repetition of steps 1) and 2) until the anatomical model has been completely built.

### BRIEF DESCRIPTION OF THE DRAWINGS

FIG. 1: Segmented digital bone model (top) and segmented digital soft-tissue model (below), both of the facial region

FIG. 2: Postprocessed digital bone model (top) and postprocessed digital soft-tissue model (below), both of the facial region

FIG. 3: Trimmed total digital model of the facial region

FIG. 4: Digital CLP model with complete cleft lip and palate on one side

### DETAILED DESCRIPTION OF THE PREFERRED EMBODIMENTS

Suitable 3D printing devices are known in the prior art and are, for example, described in WO 2016/071241 A1. The 3D printing device preferably contains at least one discharge device, a source of electromagnetic radiation and a support plate.

Preferably, the discharge device is configured such that printing compounds can be delivered in the form of individual isolated drops (voxels), as a row of drops or in the form of a strand. Smooth transitions between these forms are possible.

To deliver individual drops, the discharge device can comprise one or more nozzles which emit liquid drops of printing compound in the direction of the base plate. Such nozzles are also referred to as jetting nozzles.

To deliver strands of printing compound, the printing compound is pressed out through a nozzle as a strand by means of pressurization of a reservoir, for example from a cartridge, syringe or drum, and selectively deposited on the base plate to form the object. Such discharge devices are also referred to as dispensers.

It is possible to provide multiple and also technically different discharge devices for various printing compounds in the 3D printing device. For instance, the 3D printing device can have one or more possibly differently designed or differently operated jetting nozzles and/or one or more possibly differently designed or differently operated dispensers.

The discharge device preferably comprises jet valves having piezo elements. These make it possible to discharge both low-viscosity materials, it being possible to realize drop volumes for drops of a few picoliters (pL) (2 pL correspond to a drop diameter of approx. 0.035 μm), and medium- and high-viscosity materials such as, in particular, silicone rubber compounds, preference being given to piezo print heads having a nozzle diameter between 50 and 500 μm and it being possible to generate drop volumes in the nanoliter range (1 to 100 nL). With low-viscosity compounds (less than 100 mPa·s), these print heads can deliver droplets with a very high dispensing frequency (approx. 1 to 30 kHz), whereas with higher-viscosity compounds (above 100 Pa·s), dispensing frequencies up to approx. 500 Hz can be achieved depending on the rheological properties (shear thinning behavior). Suitable jetting nozzles are known in the prior art and are, for example, described in DE 102011108799 A1.

Preferably, the printing compounds are applied in the form of drops. Most preferably, the printing compounds are applied by means of drop-on-demand methods (DOD methods). The DOD method is particularly suitable for being able to produce complex models. In the drop-on-demand method, each printed drop is specifically generated in advance and deposited onto a defined site for the drop.

The printing compounds of the present invention comprise at least one structure-forming printing material consisting of a silicone rubber composition crosslinkable by electromagnetic radiation. A structure-forming printing material is understood in the present invention to mean a printing material which is used for building the structure of the anatomical model itself. In comparison, it is also possible to use various support materials which, however, are removed after the anatomical model has been built.

The structure-forming printing compounds can additionally comprise one or more further crosslinkable silicone rubber compositions which differ from one another. In the crosslinked state, the silicone rubber compositions can, for example, differ with respect to Shore hardness, electrical conductivity, thermal conductivity, color, transparency, hydrophilicity and/or swelling behavior.

Suitable silicone rubber compositions are known in the prior art. The silicone rubber compositions described in WO 2017/081028 A1, WO 2017/089496 A1 and WO 2017/121733 A1 are particularly suitable.

In the uncrosslinked state, the crosslinkable silicone rubber composition and/or optionally additional silicone rubber compositions preferably have a viscosity of 10 Pa·s or more, more preferably 40 Pa·s or more, yet more preferably 100 Pa·s or more, most preferably 200 Pa·s or more, and 1000 Pa·s or less, measured in each case at 25° C. and a shear rate of 0.5 s⁻¹.

The viscosity of the silicone rubber composition can be measured with a rheometer in accordance with DIN EN ISO 3219: 1994 and DIN 53019, it being possible to use a cone-and-plate system (cone CP50-2) having an opening angle of 2°. A suitable rheometer is, for example, the “MCR 302” from Anton Paar; Graz, Austria. The instrument can be calibrated using a standard material, for example standard oil 10000 from the Physikalisch-Technische Bundesanstalt [national metrology institute], Braunschweig, Germany.

The silicone rubber compositions can be one-component or multicomponent, preferably one-component, formulations. Preferably, the silicone rubber compositions used in the method according to the invention are addition-crosslinking silicone rubber compositions. Addition-crosslinking silicone rubber compositions are typically crosslinked by reaction of unsaturated groups, for example alkenyl groups, with Si—H groups (hydrosilylation) in the silicone rubber composition. The crosslinking can be induced thermally and/or by UV or UV-VIS light. Such silicone rubber compounds are, for example, known from WO 2016/071241 A1 and in the publications cited therein.

The crosslinking is achieved by UV/VIS-induced activation of a light-sensitive hydrosilylation catalyst, preference being given to platinum complexes as catalysts. Numerous light-sensitive platinum catalysts, which are largely inactive under exclusion of light and can be converted into platinum catalysts active at room temperature by irradiation with UV/VIS light, are known from the prior art.

The printing compounds can additionally comprise one or more of the following structure-forming printing materials: silicone gels, silicone resins, homopolymers or copolymers composed of monomers selected from the group consisting of acrylates, olefins, epoxides, isocyanates or nitriles, and also polymer blends comprising one or more of the aforementioned homopolymers and copolymers. Preferably, the printing compounds are materials which are present in a flowable form at least during processing and can be cured or crosslinked after discharge. The printing compounds can be one-component or multicomponent, preferably one-component, formulations.

The structure-forming printing compounds preferably comprise the above-described silicone rubber compositions in an amount of 50% by weight or more, more preferably 70% by weight or more, and most preferably 90% by weight or more, based in each case on the total weight of the structure-forming printing compounds. In a particularly preferred embodiment, the structure-forming printing compounds consist solely of silicone rubber compositions.

In the crosslinked state, the structure-forming materials can, for example, differ with respect to Shore hardness, electrical conductivity, thermal conductivity, color, transparency, hydrophilicity and/or swelling behavior.

Compositions which can be used for anatomical models are materials ranging from gelatinous materials (penetration measurement), through very soft materials of Shore AO or 00 hardness scale, right up to rigid materials of Shore D hardness scale. Preference is given to materials of Shore 00 hardness of 25 to Shore A hardness of 90. Particular preference is given to using silicones of Shore 00 hardness of 25 to Shore A hardness of 90.

Shore hardness can be measured via a Shore hardness measurement instrument, for example in accordance with DIN ISO 7619-1:2012-02 or ASTM D2240. For the measurement of the indentation hardness of elastomers, the depth of indentation of a spring-loaded pin into the material is measured. To this end, a test specimen of a specified thickness (e.g., 6 mm) is placed onto an even, hard surface and a defined indenter is applied perpendicularly to the test specimen for a defined test time, for example 3 s, with the aid of the test force. After the test time has elapsed, the Shore hardness display value can be read. A suitable instrument is, for example, the Shore A hardness tester SHA.D3 from Q-tec GmbH, Zeilarn, Germany.

A further preferred property of the printing compounds is the elasticity thereof, which is intended to reconstruct the natural behavior of certain biological tissues in a particularly realistic manner. In this case, particular preference is given to, for example, elongations at break of the printing compound of 100% to 1000%, depending on the particular material hardness, for soft tissue.

Furthermore, the printing compounds can preferably be colored such that they match the optical appearance of the biological tissue as well as possible. For example, silicone printing compounds can be colored with a variable proportion of color paste. For example, it is possible to preferably color muscles in a red tone, bones in white and skin areas in a skin tone. Furthermore, in contrast with the biological original, it is possible to choose a translucent or optically transparent material in order to be able to visually comprehend processes inside the model more easily.

A further preferred property of the printing compound is a behavior that is as realistic as possible when using the model for training. The selected printing compounds should behave like the original tissue as much as possible when cutting, severing, suturing, separating, joining with clamps or plasters, etc. What are also to preferably match the real circumstances in the body as closely as possible are the flow behavior of body fluids in, on or over the anatomical silicone models, the deformation in a manual examination by the physician, etc.

The printing compounds are therefore preferably selected such that they represent the relevant anatomical structure realistically with regard to the optical, mechanical and/or haptic properties. This can preferably be achieved by a comparison of the properties of the biological model with the printed haptic model and iterative adjustment of the selection of material.

What is to be ensured by the systematic investigation of the properties and the behavior of the printed models is a representation of the properties of the biological original that is as realistic as possible. To this end, values for the biological tissue that are known from the literature are used as the basis for comparison. If such values do not exist, experiments are carried out on biological samples in order to generate comparative values. Different investigations are subsequently carried out on the models. These can include geometrical investigations, density measurements, tensile tests, relaxation tests, static and dynamic loading tests, static and dynamic deformation tests and hardness measurements. Furthermore, these investigations can be extended by evaluations specifically matched to the medical environment, such as haptic investigations, cutting tests, flow behavior, behavior when separating different layers and suturing behavior.

These investigations form the basis for the subsequent clinical evaluation. Here, in the first step, the digital and haptic models per se are looked at by medical experts and evaluated with regard to their properties, such as, for example, depiction of anatomy, handling and quality. If the models are practice models, they are, in a second step, used in a medical simulation, i.e., appropriate examinations or treatments are carried out on the particular model. Here, the situation and performance of the examination and treatment is to approximate a clinical situation on a real patient as closely as possible. The behavior of the models in the medical simulation can be evaluated by skilled medical personnel and also by technical experts.

On the basis of the results of all investigations, the models in development are iteratively adjusted and further developed in order to thus generate models that are as realistic as possible.

In a preferred embodiment, the printing compounds additionally comprise one or more support materials which are removed after completion of the building of the anatomical model.

The placement of support material may be necessary if the anatomical model is to have cavities, undercuts or overhanging, self-supporting or thin-walled parts, since the printing compounds cannot be placed such that they are floating freely in space. The support material fills out spatial volumes during the printing process and serves as foundation or as scaffold so that the printing compounds can be placed and cured thereon. The support material is removed after completion of the printing process and clears the cavities, undercuts and overhanging, self-supporting or thin-walled parts of the printed object. In addition, support material can also be provided at points at which it is technically not absolutely necessary. For example, components can be packed in support material in order to increase the quality of the printed result or to influence the surface quality of the printed product.

What is generally used as support material is a material which differs from the material of the anatomical model to be printed, for example noncrosslinking and noncohesive material. The required shape of the support material is calculated depending on the geometry of the object. Various strategies can be used in the calculation of the shape of the support material in order, for example, to use as little support material as possible or in order to increase the size accuracy of the product.

If support material is used, the print head can have one or more further discharge devices for the support material. Alternatively or additionally, a further print head having corresponding discharge devices can also be provided for the discharge of support material. Suitable support materials are known in the prior art. Support materials as described in WO 2017/020971 A1 are particularly suitable.

In the method according to the invention, a crosslinking or incipient crosslinking of the applied printing compound by electromagnetic radiation takes place. The electromagnetic radiation preferably acts on the printing compounds in a site-selective or extensive manner, in a pulsed or continuous manner and with a constant or varying intensity.

It may be appropriate to irradiate the entire work area constantly during printing in order to achieve complete crosslinking, or to expose it only briefly to the radiation in order to specifically cause an incomplete crosslinking (incipient crosslinking/green strength), and this may be associated with a better adhesion of the individual layers among one another in some circumstances.

The crosslinking or incipient crosslinking of the printing compounds is preferably achieved thermally and/or by UV or UV/VIS radiation, very particularly preferably by UV or UV/VIS radiation.

UV radiation has a wavelength in the range from 100 nm to 380 nm, whereas visible light (VIS radiation) has a wavelength in the range from 380 to 780 nm.

UV/VIS-induced crosslinking has advantages compared to a thermal crosslinking. Firstly, UV/VIS radiation intensity and action time and site of action of the UV/VIS radiation can be precisely measured, whereas the heating of the discharged structure-forming printing materials (and also the subsequent cooling thereof) always takes place in a delayed manner owing to the relatively low thermal conductivity. Because of the intrinsically very high thermal expansion coefficient of the silicone rubber compositions, the temperature gradients inevitably present in the case of thermal crosslinking lead to mechanical stresses which can have an adverse effect on the size accuracy of the object formed, and this can lead to unacceptable distortions of shape in extreme cases.

The rate of UV/VIS-induced crosslinking depends on numerous factors, especially on the nature and concentration of the light-sensitive catalyst, on the intensity, wavelength and action time of the UV/VIS radiation, on the transparency, reflectivity, layer thickness and composition of the printing compound and on the temperature.

The silicone rubber compounds which crosslink with UV/VIS induction are preferably cured by using light of wavelength 240 to 500 nm, more preferably 250 to 400 nm, yet more preferably 350 to 400 nm, and especially preferably 365 nm.

To achieve rapid crosslinking, which is to be understood to mean a crosslinking time at room temperature of less than 20 min, preferably less than 10 min, and most preferably less than 1 min, it is recommended to use a UV/VIS radiation source having an output between 10 mW/cm² and 20,000 mW/cm², preferably between 30 mW/cm² and 15,000 mW/cm², and a radiation dose between 150 mJ/cm² and 20,000 mJ/cm², preferably between 500 mJ/cm² and 10,000 mJ/cm². Within the scope of these output and dose values, it is possible to realize area-specific irradiation times between not more than 2000 s/cm² and not less than 8 ms/cm².

If printing compounds which cure under UV/VIS action are used, the 3D printing device preferably has a UV/VIS illumination unit.

In the case of site-selective illumination, the UV/VIS source is arranged in a movable manner relative to the base plate and illuminates only selected regions of the object. In the case of an extensive illumination, the UV/VIS source is, in one variant, designed such that the entire object or an entire material layer of the object is illuminated at once. In a preferred variant, the UV/VIS source is designed such that its light level or its energy can be adjusted in a variable manner and that the UV/VIS source illuminates only a subregion of the object at the same time, it being possible to move the UV/VIS source relative to the object such that the entire object can be illuminated with the UV/VIS light, optionally in differing intensity. For example, the UV/VIS source is designed as a UV/VIS LED strip for this purpose and is moved relative to the object, or over the printed object.

In the case of thermally crosslinkable printing compounds, the crosslinking can be achieved by IR radiation, for example by means of an (N)IR laser or an infrared lamp.

Curing is carried out by using a curing strategy. Preferably, the printing compounds are cured after placement of one layer, after placement of multiple layers or directly during printing.

A curing of the printing compounds directly during printing is referred to as a direct curing strategy. If, for example, structure-forming printing materials curable by UV/VIS radiation are used, the UV/VIS source is active for a very long time in comparison with other curing strategies, and so it is possible to work with a very much lower intensity, this leading to a slow crosslinking through the object. This limits the warming of the object and leads to size-accurate objects, since expansion of the object because of temperature peaks does not occur.

In the case of the per-layer curing strategy, what takes place after the placement of each complete material layer is the radiation-induced crosslinking of the placed material layer. During this operation, the freshly printed layer is joined to the cured underlying printed layer. Curing does not take place immediately after the placement of a printing compound, and so the printing compounds have time to relax before curing. This means that the printing compounds can flow into one another, and a smoother surface than in the case of the direct curing strategy is achieved as a result.

In the case of the n-layer curing strategy, the procedure carried out is similar to the procedure in the per-layer curing strategy, but curing is only performed after the placement of n material layers, where n is a natural number. The time available for the relaxing of the printing compounds is further increased, and the surface quality further improves as a result.

The anatomical model consists of one or more silicone elastomers preferably to an extent of 50% by weight or more, more preferably 70% by weight or more, and most preferably 90% by weight or more, based in each case on the total weight of the anatomical model. In a particularly preferred embodiment, the anatomical model consists solely of one or more silicone elastomers.

In a preferred embodiment of the invention, the anatomical model is produced on the basis of a digital 3D model generated from anatomical measurement data.

In this case, the anatomical measurement data can, for example, be obtained by medical imaging methods or surface scans.

To this end, different methods capturing certain body regions both inside the body (such as, for example, organs, muscles, bones, tissues) and on the surface of the body of a human can be used. To this end, surface scan methods can be used, such as, for example, laser scan methods which capture external body regions or, by introduction into body openings, map cavities therebehind (e.g., in the oral cavity or in the auditory canal). Furthermore, medical imaging methods can be used for data acquisition, such as, for example, radiographs, computed tomography (CT), magnetic resonance imaging (MRI), nuclear medicine (NUC), positron emission tomography (PET), ultrasound examinations, scintigraphy or combinations thereof.

When acquiring data, care has to be taken that the anatomical regions required for the silicone model are mapped completely and with a sufficient resolution. In the case of medical image data, it may, for example, be necessary to use a contrast agent for the depiction of the blood vessels (or the blood flow within the lumen).

From the acquired data, it is possible to create a digital 3D model. The basis used for the digital model is the acquired medical image data or data from the surface scanner. The scanner data are usually directly available as surface data sets, for example in .stl format. The medical data are usually available as layer data sets. In this case, what are of particular interest are so-called DICOM data (Digital Imaging and Communications in Medicine), which are a medical data standard for radiography, MRI, CT and sonography. This involves the assignment of a gray value, signal value or parameter value to each pixel in the case of 2D images or to each voxel in the case of tomograms. In addition, the DICOM format contains further information such as, for example, patient data or layer thickness. Alternatively, the data can, for example, also be available in .nrrd format.

A surface model is created from the medical layer data by means of segmentation. Segmentation realizes the transition from unstructured pixels or voxel quantities to interpretable objects (segments). Each pixel or voxel is assigned in this case to a certain segment. This is used in order to differentiate specific tissue classes and/or anatomical structures from one another and to define them as unambiguously associated. In the case of manual segmentation, the relevant structure in each individual layer image is labeled. In the case of automatic segmentation methods, which are subdivided into pixel-, edge- and region-based methods and combined with one another, this process can be quickened in time. Pixel-oriented thresholding methods bring together content-related regions, or pixels or voxels, having the same gray value according to a homogeneity criterion. The underlying homogeneity criterion is the Hounsfield scale (HU scale, Hounsfield units). The HU scale allows a standardized comparison of various CT images by relating the attenuation coefficient of a certain tissue to that of water (0 HU). Segmentation can be carried out either by user interface-oriented software tools or by direct programs. The resultant segments can subsequently be exported as surface models, for example in .stl format. Depending on the anatomical structure considered, the data set available and the planned model use, it may also prove practical to combine multiple data sets, for example MRI and CT, and/or multiple software programs. Software combination can, for example, be achieved via an intermediate export of one preliminary model stage as .stl file from a first program and the transmission thereof back to the layer data in a second program. This may be useful when the programs provide different tools for segmentation. Combining with a direct segmentation program code is, too, productive here in some circumstances.

The digital 3D model can be digitally postprocessed before the printing of the anatomical model. The postprocessing of the digital anatomical models can be done in a volume-, network- and/or point-based manner. The digital models can be postprocessed by using different programs and software environments, which range from classic engineer tools such as CAD programs up to intuitive manual design environments.

First of all, the network of the surface models, obtained directly from the surface scanner or indirectly from medical image data via segmentation, is examined for errors, cleaned up and, if necessary, smoothed for further processing. To be able to handle the quantity of data from the models, a network simplification by reduction of the triangular surfaces is also striven for. The stated steps for network handling are required after further model processing steps as well in iterative loops.

To create generic models, the surface created from medical image data and/or scanning data can be adjusted according to the requirements. This can, inter alia, be used to represent different anatomical characteristics, such as, for example, to specifically generate defined pathologies or to correct undesired (atypical) anatomies of the patient scan used. To this end, the following manipulation options can be used in an automated or manual manner in any combination, selection and iteration:
Boolean operations (combination, subtraction, blending) of two or more surface models
trimming of the models
scalings
addition of material via offset functions
creation of hollow structures
generation of gaps
generation of holes
generation of bridges
addition of volume
subtraction of volume
deformation of the network
shifting of network nodes
rounding of surfaces
smoothing of surfaces

These manipulation options can also be used in order to create an overall model consisting of multiple surface models and, optionally, to coordinate the individual components.

Furthermore, a parametrization of the model is possible. Thus, certain constructed geometrical features can be adaptively adjusted by entering or altering a parameter. This parametrization is also combinable with a user interface, and so, by using the user interface, even inexperienced constructors can put together their own model with the relevant clinical picture.

Furthermore, the anatomical model can be post-treated or postprocessed after printing. The post-treatment is preferably selected from one or more of the following methods: heat treatment, surface coating, making of cuts, division and removal of segments and joining of individual components. For example, a heat treatment of the component can take place at 200° C. for 4 hours. This corresponds to a tempering treatment typical for silicone elastomers. A particularly suitable tempering treatment is described in WO 2010/015547 A1.

Furthermore, the models can be coated regionally or globally after 3D printing in order, for example, to optimize the surface properties of the model. The properties which can be optimized by a coating include, for example, surface roughness, coefficient of friction, color, transparency of the component, reduction of the step effect of 3D printing, application of a surface layer differing on the material side from the actual component, etc. A further option in postprocessing is, for example, the making of cuts, division and/or removal of individual segments, or joining of individual components.

The present invention further relates to an anatomical model which is produced by the above-described 3D printing method. In this connection, the anatomical model can also be produced by the combination of such a 3D printing method with at least one other additive or conventional manufacturing technology.

The anatomical model produced according to the invention preferably corresponds to healthy human anatomy or to a certain clinical picture (pathology). These may be present in different characteristic forms and combinations. The anatomical model produced according to the invention preferably copies a cleft lip and palate, blood vessels, heart or brain ventricle. Furthermore, the anatomical model produced according to the invention can be a generic or a patient-specific model.

A preferred property of the anatomical models is that they represent the relevant anatomical structure realistically with regard to the optical, mechanical and/or haptic properties. This can preferably be achieved by a comparison of the properties of the biological model with the printed haptic model and iterative adjustment of the selection of material.

A further preferred property of the anatomical models is that different tissue types are depicted as realistically as possible with regard to their hardness. A particularly preferred property of the anatomical models is a realistic representation of soft tissue by silicones of different Shore hardnesses.

A further preferred property of the models is the elasticity thereof, which reconstructs the natural behavior of certain biological tissues in a particularly realistic manner. In this case, particular preference is given to, for example, elongations at break of the printing compound of 100% to 1000%, depending on the particular material hardness, for soft tissue.

Furthermore, the models can preferably be colored such that they match the optical appearance of the biological tissue as well as possible. For example, it is possible to color muscles in a red tone, bones in white and skin areas in a skin tone. Furthermore, in contrast with the biological original, it is possible to choose a translucent or optically transparent material in order to be able to visually comprehend processes inside the model more easily.

A further preferred property of the anatomical model is a behavior that is as realistic as possible when using the model for training. The manufactured models are to behave like the original as much as possible when cutting, severing, suturing, separating, joining with clamps or plasters, etc. What are also to preferably match the real circumstances in the body as closely as possible are the flow behavior of body fluids in, on or over the anatomical silicone models, the deformation in a manual examination by the physician, etc.

What is achieved by the invention proposed here is a direct additive manufacturing of anatomical models made of silicones, i.e., a digital model is directly converted to a haptic silicone model via a 3D printer. The creation of molds or lost cores and also the manual or automated casting of the molds is not necessary. As a result, the production of the models is simplified and costs can be saved. Furthermore, it is possible to manufacture complex anatomical models in a problem-free manner by direct 3D printing in a droplet-based method in combination with a support material, as described in the presented invention.

This invention also encompasses the complete process chain from the digital acquisition of the anatomical model right up to the realization in 3D printing and a possible postprocessing. What is advantageous in this connection is that, during model creation, peculiarities of the droplet-based 3D-printing process can be taken into account. For example, regions of different hardness can be assigned to different model parts during model creation and then realized in different material types. Furthermore, features of the model (cavities, minimum wall thicknesses, radii, etc.) can be adjusted by constructive measures such that the digital anatomical model can be realized by the described 3D-printing technology.

A further novel step is the constructive modification of the anatomical model. For instance, proceeding from a digital model, it is possible by artificial adjustment and manual modelling/manipulation of the model to artificially achieve a different manifestation of anatomical elements.

Furthermore, clinical pictures, such as, for example, deformities in the facial region, can be specifically introduced into the model by manipulation. Combined with silicone 3D printing, it is thus possible to additively manufacture unique models.

By means of this digital workflow combined with the additive manufacturing allowing an automated manufacture of individual pieces, it is possible, proceeding from a base model, to create any number of haptic models which differ in their anatomical structures and in the nature, number, size, location, etc., of defects and clinical pictures.

Besides this manipulative modification of a real anatomy, it may, however, also be desirable to exactly reconstruct the anatomy of a specific patient. The acquisition of the specific patient data, and segmentation of said data that is as accurate as possible, make this possible. On the basis of the anatomical model created, operations can be planned and practiced, patient education is facilitated and implants can be selected and “tried” in advance. Owing to the representation of the entire process and the direct manufacturing of the silicone model in 3D printing, this process is quickened and optimized. Furthermore, it is thus also possible to construct and manufacture patient-specific prostheses, epitheses, implants, etc., using specific patient data. In this case, it is of particular importance to take into account the subsequent additive manufacturing process as early as during model creation.

### EXAMPLES

Small-Child Cleft Lip-and-Palate Model (CLP Model)

a. Generation of the Digital Model:

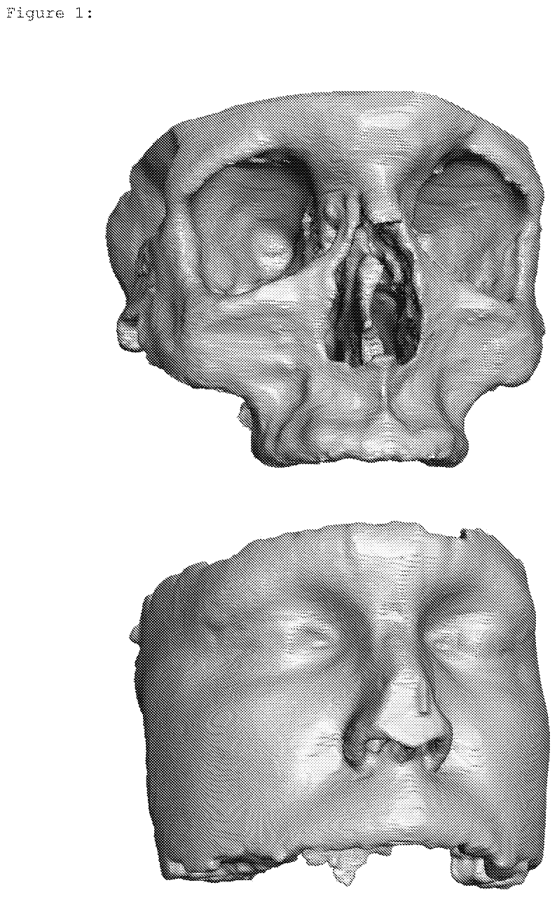

The starting point is a DICOM data set from an adult in the facial region. Of this, the upper jaw and the adjoining bone regions without the teeth are segmented, as are the surrounding soft material consisting of skin, muscles and other soft-tissue structures in a second model. The segmented models are depicted in FIG. 1.

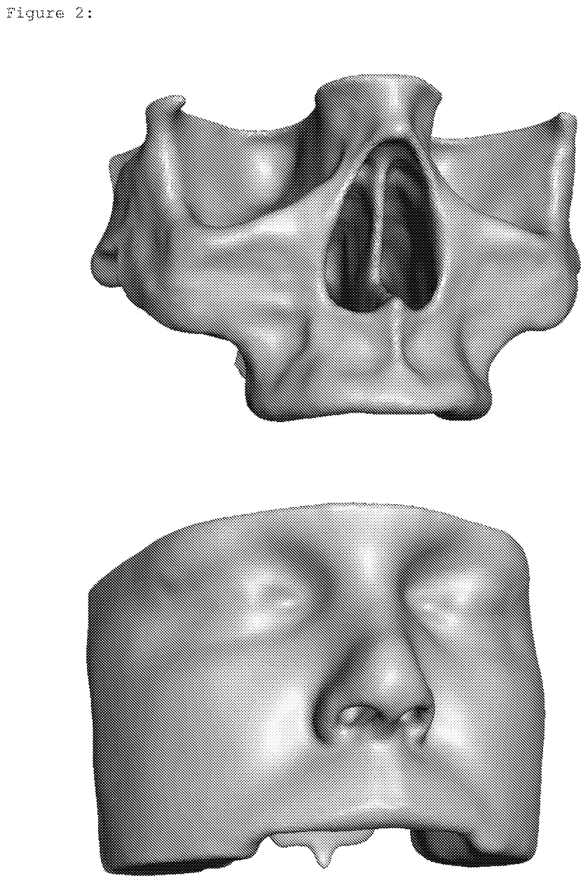

In the next step, the networks of the segmented models are repaired, holes are filled and the surfaces are smoothed. The bone contours are adjusted to those of an infant. For the soft-tissue model, the nose, nasal septum, lip contour, labial frenulum and, if necessary, further structures are shaped. For easier processing and smoothing of the inner side of the lips and cheeks, the palate is separated in the region of the hard palate. A new palate is created via an offset from the upper jaw of the bone model and is added to the soft-tissue model via Boolean operators. Thereafter, both models are each trimmed and their networks simplified and unified. The resultant models can be gathered from FIG. 2.

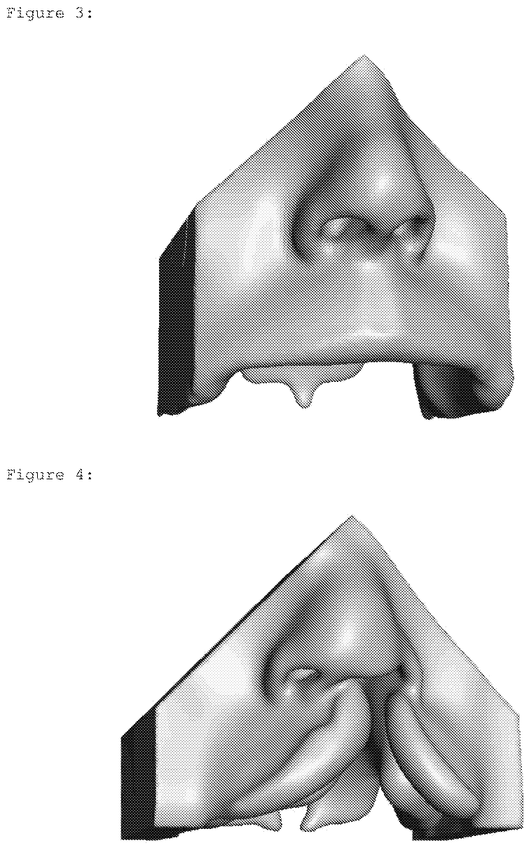

Thereafter, the two models are converted into an overall model. If individual points of the external contours of the soft-tissue model are too close to that of the bone model, the points are reinforced by addition of volume and the transitions are then smoothed. The overall model is then trimmed to the nose and upper-jaw region. Via offset functions, a shell is generated around the bone model, which shell is added to the soft-tissue model. Thereafter, the resultant holes between the shell and the soft-tissue model are filled and the model is trimmed again. The trimmed model is shown in FIG. 3.

Scaling, addition or subtraction of material is used to convert the adult model into a child model. To this end, the model created is measured and is compared with the dimensions for child jaws from the literature. Since, in this case, different regions are deformed to varying extents, the transitions must subsequently be adjusted and smoothed again and the whole model must be trimmed again, so that a harmonic overall picture is formed.

In the next step, artificially selected muscles, levator palatini, tensor palatini and M. ocl oris, are additionally added to the model. To this end, the external regions of the surface network of the soft-tissue model, behind which the muscles lie, are labeled. Offset functions and smoothing tools are used to create the muscles within the soft-tissue model. By subtraction of copies of the muscles from the soft-tissue model, it is possible to create the corresponding pockets for the muscles in the model. If required, for instance for an assembly process following manufacturing, it is possible to make the pockets larger than the muscle model via offsets or to create accesses for completely embedded muscles by subtraction of volume. These adjustments are not necessary when the model is manufactured in one piece by multimaterial printing. The result is a healthy child upper-jaw model.

By movement of individual network nodes, removal and addition of volume and subsequent smoothing, it is possible to represent different pathologies, such as, for example, a cleft lip and palate on one side. Here, relevant scientific literature and the evaluation by skilled medical personnel are necessary for creating an anatomically realistic model. Since the musculature also shifts in the case of a cleft, it is necessary to recreate the relevant muscles as described above. Since the palate musculature must run along the cleft, the bone cleft if present is first enlarged in order to create space for the musculature. The muscles are then subsequently generated here as an offset of the bone structure. If necessary, the resultant model is then additionally prepared for possible assembly steps, for example by cuts for the insertion of internal structures. Lastly, all contours and wall thicknesses are checked again (according to the manufacturing parameters) and, if necessary, adjusted, and the network is cleaned up and simplified for the last time.

The finished digital CLP model with complete cleft on one side, which model can be seen in FIG. 4, is exported in its individual parts, for example as .stl files, or as an overall model in a format for multicomponent printing and is transferred to the printer.

b. Manufacturing of the Anatomical Model

The manufacturing of the CLP model can be realized either by the inventive manufacturing of the individual parts, which are later assembled, or by the inventive manufacturing of the overall model.

For the additive manufacturing of the models, ACEO® printers of the series K, 100 and 600 were used. The positioning of the components and the printing strategy used was chosen according to the component. Thereafter, the model was manufactured in accordance with the method according to the invention. In this connection, the printing parameters were optimally set with the aid of empirical values of the material being used.

What are printed for the different regions are materials of differing Shore hardness, for example 10 Shore A for the soft-tissue model and the musculature and 60 Shore A for the bone model, and also colors, for example white for the bone, red for the muscles and skin colors for the soft-tissue model.

A silicone rubber composition having a Shore hardness of 60 A was used for the bone model, and a silicone rubber composition of Shore hardness 10 A was used for the musculature and the soft tissue. Commercially available color pastes were used for coloring the models.

In the multimaterial printing, the model is manufactured from the different materials in one step. In the case of individual manufacturing of all the model components, a manual work step for assembly is additionally necessary. In general, the postprocessing of the model can encompass the making of specific cuts, removal of support material, bonding of individual segments, closure of previously generated openings, tempering, manual coating or coloring. For example, by means of a slightly red colored Shore 00 coating, it is additionally possible to simulate the mucosa of the CLP model.

In addition to the above-listed CLP models, yet further applications are very easily imaginable. These include models of different vascular structures, both healthy and diseased or with defect. Here, the different manufacturing and postprocessing parameters can be adjusted according to the requirements or to the biological model. Furthermore, representations of the heart, healthy, diseased or with defects, are also of interest. Opportunities, specifically in combination with hard or very soft materials, are also provided by brain models or models of brain structures. Just these examples reveal that the applications of silicone 3D printing for models of anatomical structures, particularly in the soft-tissue region, are very diverse.

1.-20. (canceled)

21. A method for the additive production of an anatomical model using a 3D printing device, the method comprising the following steps:
1) layer-by-layer application of printing compounds in the form of drops by means of drop-on-demand methods to a support plate, to a foreign component positioned thereon or to a previously applied printing-compound layer, the printing compounds comprising
at least two structure-forming printing materials consisting in each case of a silicone rubber composition crosslinkable by electromagnetic radiation, with the silicone rubber compositions differing from one another;
2) crosslinking or incipient crosslinking of the printing compounds by electromagnetic radiation;
3) repetition of steps 1) and 2) until the anatomical model has been completely built.

22. The method of claim 21, wherein the crosslinkable silicone rubber compositions have a viscosity of 10 Pa·s or more, measured in each case at 25° C. and a shear rate of 0.5 s⁻¹.

23. The method of claim 21, wherein the crosslinkable silicone rubber compositions have a viscosity of 100 Pa·s or more, measured in each case at 25° C. and a shear rate of 0.5 s⁻¹.

24. The method of claim 21, wherein the crosslinkable silicone rubber compositions have a viscosity of 200 Pa·s or more, measured in each case at 25° C. and a shear rate of 0.5 s⁻¹.

25. The method of claim 21, wherein the printing compounds additionally comprise one or more of the following structure-forming printing materials:
homopolymers or copolymers of acrylates, olefins, epoxides, isocyanates, nitriles, or mixtures thereof, and polymer blends comprising one or more of the afbrementioned homopolymers and copolymers.

26. The method of claim 21, wherein the crosslinking or incipient crosslinking is induced thermally and/or by UV or UV-VIS light.

27. The method of claim 21, wherein the printing compounds additionally comprise one or more support materials which are removable after completion of the building of the anatomical model.

28. The method of claim 21, wherein the anatomical model is produced on the basis of a digital 3D model generated from anatomical measurement data.

29. The method of claim 28, wherein the anatomical measurement data are obtained by medical imaging methods or surface scans.

30. The method of claim 28, wherein the digital 3D model is digitally postprocessed before the printing of the anatomical model.

31. The method of claim 30, wherein the digital postprocessing comprises one or more of the following methods: Boolean operations of two or more digital 3D models, trimming, scaling, addition of material via offset functions, creation of hollow structures, generation of gaps, generation of holes, generation of bridges, addition of volume, subtraction of volume, deformation of structures, shifting of structures, rounding of surfaces and smoothing of surfaces.

32. The method of claim 21, wherein the anatomical model is post-treated or postprocessed after printing.

33. The method of claim 32, wherein the post-treatment comprises one or more of the following methods: heat treatment, surface coating, making of cuts, division and removal of segments and joining of individual components.

34. An anatomical model produced by the method of claim 21.

35. An anatomical model produced by a combination of the method of claim 21, with at least one other additive or conventional manufacturing technology.

30. The anatomical model of claim 34, wherein the anatomical model corresponds to healthy human anatomy or to a clinical picture.

37. The anatomical model of claim 35, wherein the anatomical model corresponds to healthy human anatomy or to a clinical picture.

38. The anatomical model of claim 34, wherein the anatomical model. copies a cleft lip and palate, blood vessels, heart or brain ventricle.

39. The anatomical model of claim 34, wherein the printed anatomical model is a generic or a patient-specific model.
